(19) United States
(12) Patent Application Publication
(10) Pub. No.: US 2003/0075923 A1
(43) Pub. Date: Apr. 24, 2003

(54) Air filter, intake duct and assembly consisting of a filter and an intake duct of this kind

(75) Inventor: Henri Lepoutre, Roubaix (FR)

Correspondence Address: Edward G. Greive, Renner, Kenner, Greive, Bobak, Taylor & Weber, Fourth Floor, First National Tower, Akron, OH, 44308-1456, US

(73) Assignee: WECOSTA

(21) Appl. No.: 10/272,807

(22) Filed: Oct. 17, 2002

(30) Foreign Application Priority Data
Oct. 24, 2001 (FR) 01 13739

(51) Int. Cl. F16L 35/00

(52) U.S. Cl. 285/330; 285/27; 285/921; 285/914

(57) ABSTRACT

Air filter (F), especially for an internal combustion engine motor vehicle, comprising a duct (1) for coupling to an intake duct (5), a female portion (3) of the connecting duct being intended to cover a male portion of the intake duct, characterized in that the female portion (3) has two parallel longitudinal openings (7), the two openings (7) being preferably diametrically opposed, and the female portion (3) includes an end-piece in the form of a frustoconical chamfer (4), so that the female portion (3) is of greater size in cross section than the remainder (2) of the coupling duct (1), and means, preferably removable means, are provided for fastening the filter to the intake duct (5).

### TECHNICAL FIELD

The present invention relates to an air filter, in particular for an internal combustion engine motor vehicle. The present invention also relates to an intake duct, especially a thermoformed intake duct made of a non-woven material. The present invention also relates to an assembly consisting of a filter according to the invention and an intake duct according to the invention.

### BACKGROUND ART

Air intake ducts, especially for internal combustion engine motor vehicles, which are produced by thermoforming, made of a non-woven material, especially polyester, include, because of the method of manufacture by moulding, two flanges parallel to the longitudinal axis of the duct and projecting from the outer surface of the duct, these being in particular diametrically opposed. These two flanges serve to produce the joint by welding or by another method of bonding the two half-shells formed by moulding so as to obtain the final intake duct.

Conventional air filters, which are generally made of rigid plastic, and in the form of a duct, are fitted tightly into the duct of the air filter. The existence of the flanges no longer allows a sealed joint of this kind to be made between the filter and the intake duct.

### DISCLOSURE OF THE INVENTION

One object of the invention is to provide an air filter that can be connected simply and easily to the intake duct of an intake manifold, especially an intake duct having two flanges projecting from its outer surface, while still providing a good seal with respect to the gases transported inside the filter and to the intake duct, that is to say as good as in the case of the filter/intake duct couplings of the prior art.

According to the invention, the air filter, especially for an internal combustion engine motor vehicle, comprising a duct for coupling to an intake duct, a female portion of the connecting duct being intended to cover a male portion of the intake duct, is characterized in that the female portion has two parallel longitudinal openings, the two openings being preferably diametrically opposed, and the female portion includes an end-piece in the form of a frustoconical chamfer, so that the female portion is of greater size in cross section than the remainder of the coupling duct, and means, preferably removable means, are provided for fastening the filter to the intake duct.

By thus providing, on the one hand, longitudinal openings for housing flanges formed on the outer surface of a thermoformed intake duct and, on the other hand, a rim in which the free end of the intake duct butts, it is possible to fit the filter onto the intake duct and obtain good sealing of the joint between the filter and the intake duct, the fastening means then allowing this seal to be maintained.

According to one particularly preferred embodiment of the invention, the fastening means include at least one window which is formed in the wall of the female portion and into which at least one protuberance formed on an outer surface of the intake duct is intended to clip. A particularly simple and well-sealed fastening of the filter to the intake duct is thus obtained.

According to a preferred embodiment of the invention, two windows diametrically opposed to each other are provided, preferably along the diameter of the cross section perpendicular to the diameter along which the two diametrically opposed openings are placed.

According to a preferred embodiment, the longitudinal openings are covered by hollow ribs, the dimensions of which are sufficient to house the flanges of the intake duct.

The present invention also relates to an intake duct produced by thermoforming, made of non-woven material, especially polyester, which includes two flanges parallel to the longitudinal axis of the duct, projecting from this outer surface of the duct, these being in particular diametrically opposed.

According to the invention, this thermoformed intake duct includes, at its free end, an annular bulge intended to butt against a chamfer of an air filter according to the invention.

Furthermore, the intake duct according to the invention may also include fastening means for fastening it to the air filter, and in particular these fastening means may consist of at least one protuberance, preferably two diametrically opposed protuberances, intended to clip into one or more windows formed in the female portion of a filter according to the invention.

According to one particularly advantageous embodiment of the invention, the annular bulge has a front edge making an angle, especially of 300 to 50°, with the longitudinal axis of the duct, and the front edge is deformable especially because of the flexibility or elasticity of the material from which the end-piece is formed, in order to butt against a chamfer of a filter, which chamfer makes an angle of between 50° and 70° to the longitudinal axis.

Thus, when the bulge formed at the free end of the duct butts against the filter, the latter bears against the chamfer and deforms slightly in order to obtain an inclination which will, for example, be about 60°, which will contribute to improving the seal, the duct being firmly held in place against this chamfer by the fastening means, especially by the engagement between the windows and the protuberances. In addition, this eliminates any play between the filter and the duct.

According to one particularly preferred embodiment of the invention, the protuberances are produced, in cross section, in the form of progressive steps. This makes it possible to soften the transition for the flow of the fluid at the protuberances a soft transition is formed allowing a steady flow to be maintained.

According to a further advantageous embodiment, a step is also formed on the flanges on each side of the latter. This step shape of the cross section at the flanges also makes it possible to maintain a steady and uniform flow of the fluid.

The present invention also relates to an assembly consisting of an air filter and an intake duct according to the invention.

### BRIEF DESCRIPTION OF THE DRAWINGS

An embodiment of the invention, given solely as an example, will now be described with reference to the appended drawings in which:

FIG. 1 is a perspective view of a filter duct and of an intake duct;

FIG. 2 is a perspective view of the filter duct and of the intake duct of FIG. 1 in the assembled state;

FIG. 3 is a longitudinal sectional view of part of FIG. 2, at the joint between the two ducts;

FIG. 4 is a cross-sectional view on the line IV-IV in FIG. 3;

FIG. 5 is a cross-sectional view of an alternative embodiment of a filter duct and of an intake duct according to the invention; and

FIG. 6 is a perspective view of the embodiment shown in FIG. 5.

### PREFERRED EMBODIMENT FOR CARRYING OUT THE INVENTION

The figures show the end of a duct 1 of the filter F. This duct 1 is of cylindro-circular shape. It consists of a first portion 2 with a first diameter and of a second portion 3, or female portion, with a diameter greater than that of the first diameter, the two portions being coupled by an end-piece 4 in the form of a frustoconical chamfer. This chamfer 4 extends over the entire peripheral perimeter of the duct.

The figures also show an intake duct 5 formed by thermoforming, made of non-woven material, especially polyester. This intake duct 5 consists of two semicylinders joined at two flanges 6 parallel to the longitudinal axis of the duct. The join is made especially by welding or heat sealing the flanges of the two half-shells or semicylinders to each other. Two diametrically opposed longitudinal slots 7 are formed over the entire length of the female portion 3 of the filter F, into which slots the flanges 6 are intended to slip during insertion of the filter F and especially when its female portion 3 passes over the intake duct 5.

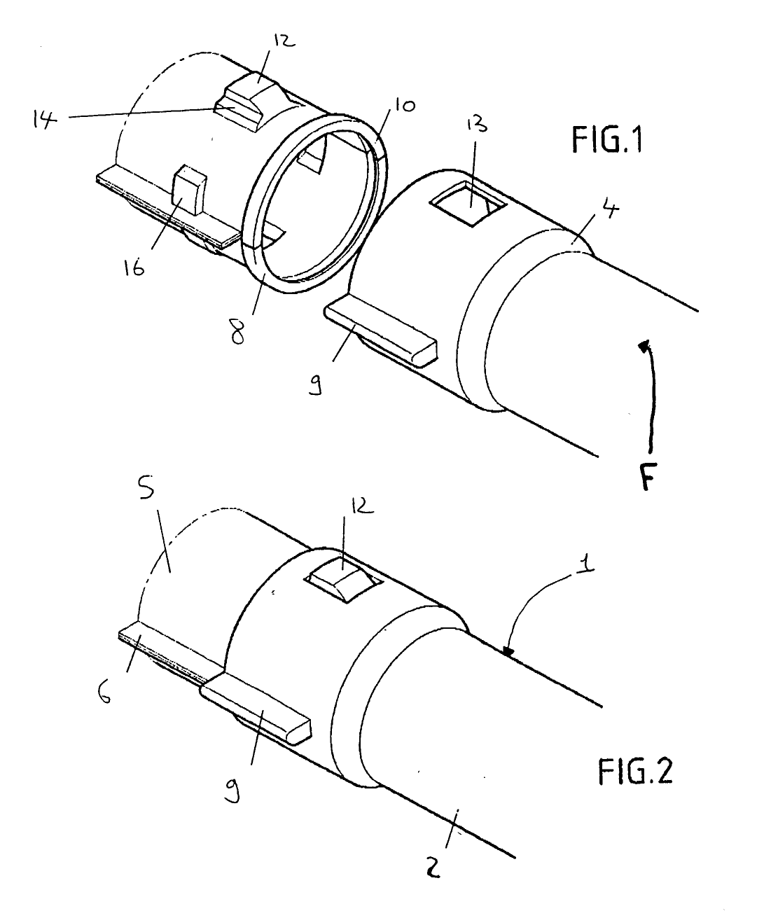

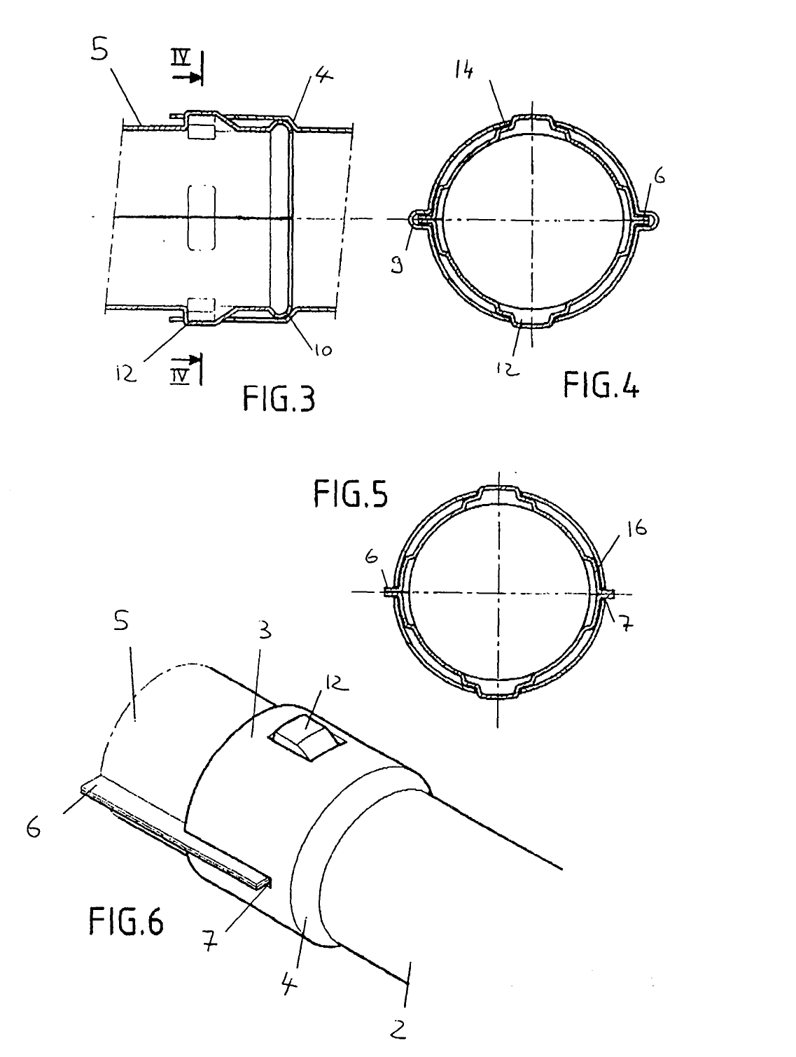

According to a preferred embodiment of the invention, which may be seen in FIG. 1 in particular, the two longitudinal slots 7 are covered by two ribs 9 formed on the filter F and projecting from this filter F, and these two ribs have dimensions large enough to cover the flanges 6.

At the free end of the intake duct 5, that is to say the end intended to be slipped into the female portion of the filter F, an annular bulge 8 is formed over the entire periphery of the duct. This annular bulge 8 may be formed especially by bending. The front edge 10 of this bulge 8 of the duct 5 makes in particular an angle of about 45° with the longitudinal axis of the duct. The dimensions, especially the maximum diameter of the bulge 10, correspond to the inside diameter of the female portion 3 of the filter F. When the duct is inserted into the filter, as can be seen in FIG. 2, the bulge butts against the chamfer 4 of the filter and deforms because of its flexibility in the opposite direction to the movement. The angle that the chamfer then makes with the longitudinal axis increases to approximately 60°, which corresponds to the angle that the chamfer makes with the longitudinal axis. Thus, good sealing is obtained at the interface between the intake duct and the filter F. In addition, this eliminates any play.

Formed a certain distance from this bulge 8 along the longitudinal axis of the duct are two protuberances 12 projecting from the intake duct. These two protuberances 12, especially formed as one piece directly from the compression moulding of the two half-shells, project, on the one hand, beyond the intake duct, but also beyond the diameter defined by that of the female portion 3 of the filter. Furthermore, a window 13 is formed some distance from the chamfer 4 in the female portion 3 of the filter, the said window corresponding in terms of dimensions approximately to the dimensions of the protuberance 12 so that the latter can be clipped into the window 13 and maintain, by clip-fastening, the joint between the duct 5 and the filter F. Preferably, one protuberance and one opening are formed at the top of the figure and at the bottom of the figure, that is to say along a diameter of the duct perpendicular to the diameter along which the two external flanges extend.

Finally, in order to allow a certain softness continuity of the gas flow while the gas passes from the intake duct to the filter, two steps 14 are formed on the protuberances 12, on either side of each protuberance, as may be seen in the cross-sectional view of FIG. 2. These two respective steps 14 of the protuberance 12 make it possible to maintain a degree of constancy of the gas flow, and therefore of the speed of the gases between the duct and the filter, and to prevent localized formation of vortices.

For the same purpose, steps 16 may also be formed on the flanges in order thus to increase the cross section of the duct so that it corresponds better to the filter F and at the same time prevent excessively abrupt discontinuities during passage of the gas flow at the intake duct where the flanges are located.

Furthermore, these two steps or reliefs make it possible for the end-piece of the casing to be properly centred with respect to the duct.

The cross section of the various ducts here is circular. Of course, it may have a cylindrical shape, for example square, rectangular, elliptical, hexagonal, etc.

What is claimed is:

1. An air filter, especially for an internal combustion engine motor vehicle, comprising a duct for coupling to an intake duct, a female portion of the connecting duct being intended to cover a male portion of the intake duct, wherein the female portion has two parallel longitudinal openings, which are intended to house within them flanges which project to the outside of the wall of the intake duct with which the coupling duct is intended to engage, the two openings being preferably diametrically opposed, and the female portion includes an end-piece in the form of a frustoconical chamfer, so that the female portion is of greater size in cross section than the remainder of the coupling duct, and means, preferably removable means, are provided for fastening the filter to the intake duct.

2. The air filter of claim 1, wherein the fastening means include at least one window which is formed in the wall of the female portion and into which at least one protuberance formed on an outer surface of the intake duct is intended to clip.

3. The air filter of claim 1, wherein two windows diametrically opposed to each other are provided, preferably along the diameter of the cross section perpendicular to the diameter along which the two diametrically opposed openings are placed.

4. The air filter of claim 1, wherein the longitudinal openings are covered by hollow ribs, the dimensions of which are sufficient to house the flanges of the intake duct.

5. An Intake duct produced by thermoforming, made of non-woven material, especially polyester, which includes two flanges parallel to the longitudinal axis of the duct, projecting from this outer surface of the duct, these being in particular diametrically opposed, this thermoformed intake duct including, at its free end, an annular bulge intended to butt against a chamfer of an air filter, comprising a duct for coupling to an intake duct, a female portion of the connecting duct being intended to cover a male portion of the intake duct, wherein the female portion has two parallel longitudinal openings, which are intended to house within them flanges which project to the outside of the wall of the intake duct with which the coupling duct is intended to engage, the two openings being preferably diametrically opposed, and the female portion includes an end-piece in the form of a frustoconical chamfer, so that the female portion is of greater size in cross section than the remainder of the coupling duct, and means, preferably removable means, are provided for fastening the filter to the intake duct.

6. The duct of claim 5, wherein the intake duct may also include fastening means for fastening it to the air filter, and in particular these fastening means may consist of at least one protuberance, preferably two diametrically opposed protuberances, intended to clip into one or more windows formed in the female portion of a filter comprising a duct for coupling to an intake duct, a female portion of the connecting duct being intended to cover a male portion of the intake duct, wherein the female portion has two parallel longitudinal openings, which are intended to house within them flanges which project to the outside of the wall of the intake duct with which the coupling duct is intended to engage, the two openings being preferably diametrically opposed, and the female portion includes an end-piece in the form of a frustoconical chamfer, so that the female portion is of greater size in cross section than the remainder of the coupling duct, and means, preferably removable means, are provided for fastening the filter to the intake duct.

7. The duct of claim 5, wherein the annular bulge has a front edge making an angle, especially of 30° to 50°, with the longitudinal axis of the duct, and the front edge is deformable especially because of the flexibility or elasticity of the material from which the end-piece is formed, in order to butt against a chamfer of a filter, which chamfer makes an angle of between 50° and 70° to the longitudinal axis.

8. The duct of claim 5, wherein the protuberances are produced, in cross section, in the form of progressive steps.

9. The duct of claim 5, characterized in that a step is also formed on the flanges on each side of the latter.

10. Assembly consisting of a filter according to claim 1.

11. Assembly consisting of a duct according to claim 5.
